(19) United States
(12) Patent Application Publication
(10) Pub. No.: US 2013/0100238 A1
(43) Pub. Date: Apr. 25, 2013

(54) Call routing based on facial recognition

(71) Applicant: Vidtel, Inc., Sunnyvale, CA (US)

(72) Inventors: Scott D. Wharton, Los Altos, CA (US); Daniel P. Goepp, Daly City, CA (US)

(73) Assignee: Vidtel, Inc., Sunnyvale, CA (US)

(21) Appl. No.: 13/711,555

(22) Filed: Dec. 11, 2012

(51) Int. Cl. H04N 7/14

(52) U.S. Cl. CPC H04N 7/147
USPC 348/14.08; 348/14.12

(57) ABSTRACT

Systems, apparatus and methods for routing a caller of an incoming video call are presented. A representative frame is selected from a sequence of images from the incoming video call. The representative frame may contain a video element (e.g., a face, QR code or printout). If the video element is recognized or unrecognized, a recognition status is set. Next, a rules database blocks or directs the incoming video call, based at least in part on the recognition status, to a video or audio destination.

### CROSS-REFERENCE TO RELATED APPLICATIONS

Not Applicable.

### BACKGROUND

I. Field of the Invention

This disclosure relates generally to systems, apparatus and methods for call routing, and more particularly to video call routing based on the contents of an incoming video stream.

II. Background

Caller ID (also called calling line identification (CLID), calling number delivery (CND), calling number identification (CNID) and calling line identification presentation (CLIP)) is a telephone service that transmits a caller's phone number during call setup. Some caller ID systems provide a name associated with the caller. In the U.S., caller ID standards send data between the first and second rings using 1200 baud Bell 202 tone modulation. The data may include the date, time and calling number fields, or alternatively, date, time, calling number and name fields.

Based on this data, a call may be routed or reject. For example, a call may be routed based on a caller's full or partial number (e.g., route all calls to a west coast office based number beginning with a west coast area code). Based on this data, rules may be created to route calls to an auto-attendant, a particular or general local or remote extension, a ring group or group of extensions, or voicemail. Alternatively, rules may be used to reject a call or send the call to a particular announcement. For example, nuisance callers or withheld numbers (i.e., calls lacking caller ID) may be rejected before any extension rings. Caller ID bases routing may also be based on time. For example, a call may be routed from a particular number to a cell phone when the incoming call occurs after hours.

Call routing is performed on calls independent of the type of call. For example, live audio, prerecorded voice messages and video calls can each have the same caller ID and be similarly routed. With an increase of video calls, additional routing techniques to route video calls are desired.

### BRIEF SUMMARY

Disclosed are systems, apparatus and methods for call routing based on a video stream. According to some aspects, disclosed is a method for routing a caller of an incoming video call, the method comprising: receiving, from the incoming video call, a video stream comprising a sequence of images; selecting a frame, from the sequence of images; searching for a video element in the frame; setting a recognition status based on a searching for the video element in the frame, wherein the recognition status is one of recognized and unrecognized; and following a rule, based on the recognition status, to route the incoming video call.

According to some aspects, disclosed is a device for routing a caller of an incoming video call, the device comprising: at least one video call transceiver couple to receive the incoming video call on an incoming video line; a video frame selector coupled to the at least one video call transceiver and configured to select a representative frame from the incoming video call; a video frame searcher coupled to the video frame selector and configured to find and recognizes video element and to set a recognition status; and a rules processor coupled to the video frame searcher, wherein the rules processor is configured to use at least one of the recognition status, a called number and calling number to determine whether to route or block the incoming video call.

According to some aspects, disclosed is a device for routing a caller of an incoming video call, the device comprising: means for receiving, from the incoming video call, a video stream comprising a sequence of images; means for selecting a frame, from the sequence of images; means for searching for a video element in the frame' means for setting a recognition status based on a searching for the video element in the frame, wherein the recognition status is one of recognized and unrecognized; and means for following a rule, based on the recognition status, to route the incoming video call.

According to some aspects, disclosed is a method for receiving an incoming video call, the method comprising: receiving, from the incoming video call, a video stream comprising a sequence of images from a caller; selecting a frame, from the sequence of images, comprising a video element; and setting a recognition status based on the video element, wherein the recognition status is one of recognized and unrecognized; and following a rule, based on the recognition status, to route the incoming video call.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1, 2 and 3 illustrate an example of caller ID signaling and routing based on caller ID.

FIGS. 4 and 5 illustrate call routing based on a video stream, in accordance with some embodiments of the present invention.

FIGS. 6-10 show various call routing scenarios, in accordance with some embodiments of the present invention.

FIG. 11 illustrates an example of routing rules associated with video-based routing, in accordance with some embodiments of the present invention.

FIG. 12 shows accessing an internal database and/or an internet database, in accordance with some embodiments of the present invention.

FIG. 13 illustrates a method to route a caller of an incoming video call, in accordance with some embodiments of the present invention.

FIG. 14 shows an apparatus for routing a caller of an incoming video call, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

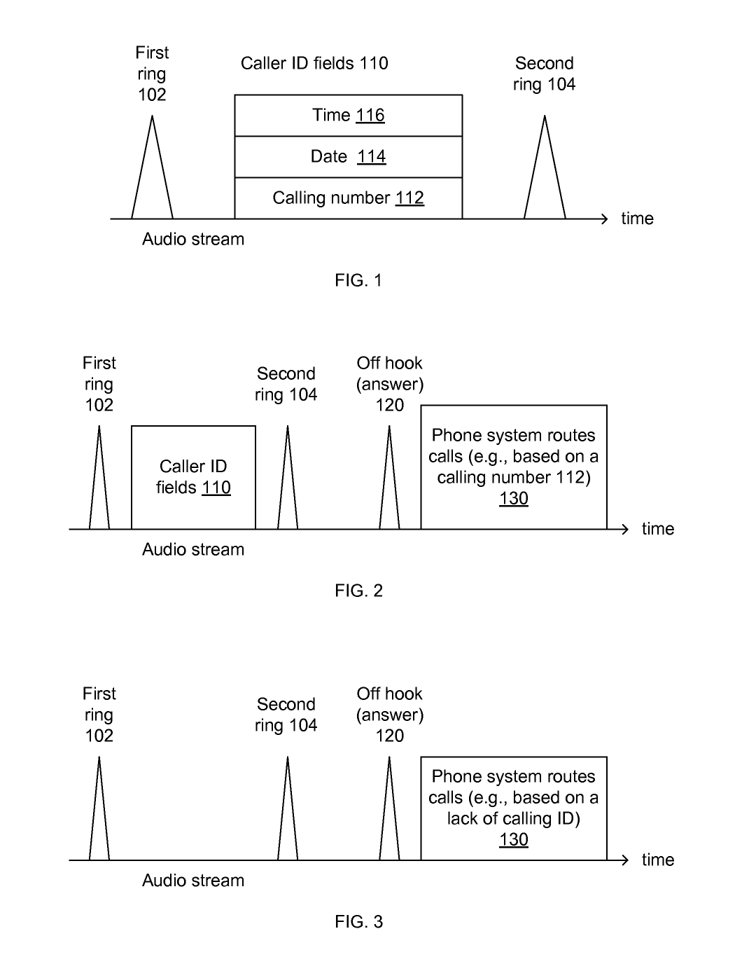

FIGS. 1, 2 and 3 illustrate an example of caller ID signaling and routing based on caller ID. In FIG. 1, a caller ID signaling is shown on a POTS (plain old telephone service) telephone line. The POTS telephone receives a first ring burst 102 followed by a second ring burst 104. In between the first ring 102 and second ring 104, the central office (CO) may send caller ID fields 110 including a calling number 112 and possibly a date 114 and a time 116.

In the example of FIG. 2, the two rings (first ring 102 and second ring 104) and caller ID fields 110 of FIG. 1 are followed by an answer or off hook 120 by a phone system (e.g., a PBX), which includes routing rules 130. The phone system then routes the incoming call based on at least one of the caller ID fields 110 (e.g., calling number field 112).

In FIG. 3, a scenario is shown of an incoming call without any caller ID fields. A phone system may route the incoming call, using routing rules 130, based on a lack of caller ID.

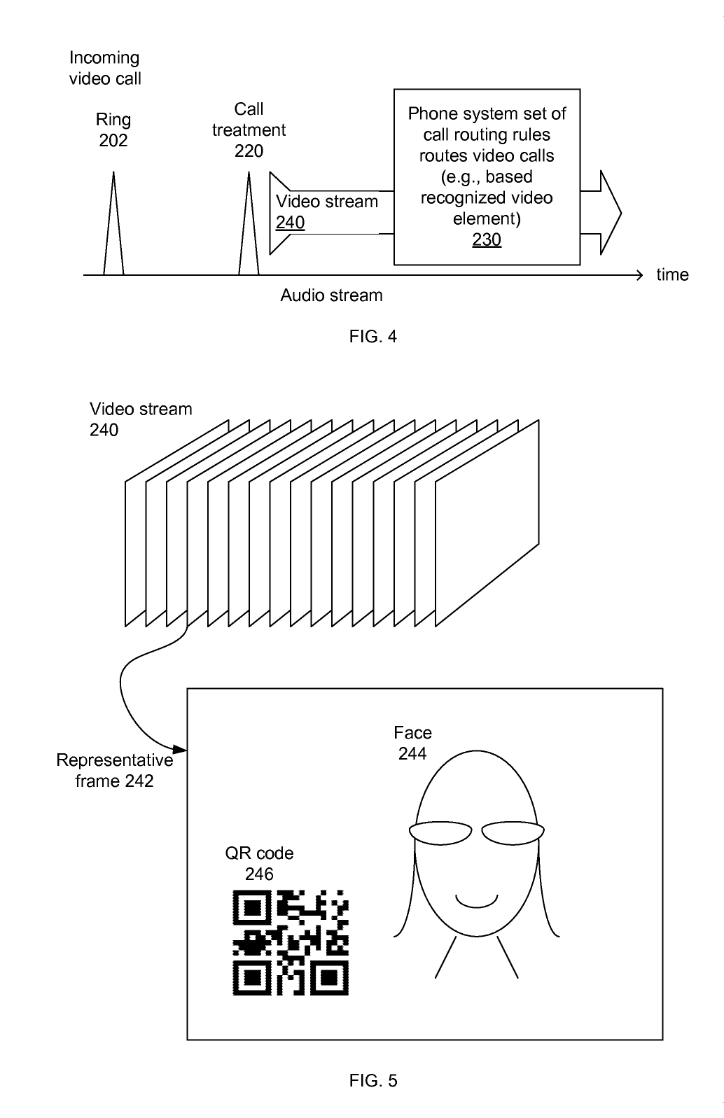

FIGS. 4 and 5 illustrate call routing based on a video stream, in accordance with some embodiments of the present invention. In FIG. 4, an incoming video call is received. A ring signal 202 is followed by call treatment 220. The call treatment 220 acts similar to the answer or off hook 120 of a POTS call. An audio stream and video stream 240 is received by the phone system. Depending on the protocol used, the audio stream may be embedded within the video stream 240 or a separate stream. The caller ID fields 110 may or may not be present with the incoming video call.

In FIG. 5, the phone system receives a video stream 240 for the incoming video call. For example, the incoming video call may include a plurality of interleaved or non-interleaved frames referred to here as a video stream 240. The incoming video call may follow at least one of an H.323 standard, a SIP standard, a WebRTC standard and an XMPP standard. The phone system selects a representative frame 242 from the video stream 240 of the incoming video call. The representative frame 242 may include an image of an in-focus caller's face (e.g., face 244). The representative frame 242 or at least a portion of the representative frame 242 may be displayed on a display to the called party (i.e., callee). For example, a face found in the representative frame 242 may be displayed in its entirety or zoom in on just the face of the caller.

Alternatively or in addition to, the representative frame 242 may include an object or other video element, such as a printed sheet of paper with encoded or unencoded text, an icon, an image and/or a quick response code (e.g., QR code 246). The QR code 246 or other object may include a URL, a password, a name of the caller, a name of a called party (also referred to as a callee), an extension, a video or audio conference “room” number (e.g., for a particular video conference), call origination information, call destination information, and/or the like such as an index to a database to said information.

A processor performs recognition on the representative frame 242, for example, by recognizing the caller's face (e.g., face 244) and/or object, such as a QR code 246. From the recognition, a set of call routing rules 230 routes the incoming video call to a particular video or audio service. For example, after answering, call treatment may route the incoming video call to record audio voice mail or to record video mail. Alternatively, call treatment may route incoming video call to a number based on a follow-me routing rule to a particular extension or group of extensions, or to an audio or video announcement. Alternatively, call treatment may block the incoming video call. That is, a result of recognition may be used by the set of call routing rules 230 to decide how to route the incoming video call, as either a video call or audio call, to a particular destination or set of destinations. The set of call routing rules 230 may further be based on a current time of day and/or day of week in its routing decision. For example, an incoming video call is routed to a particular operator during working hours and a voice mailbox during nights and weekends.

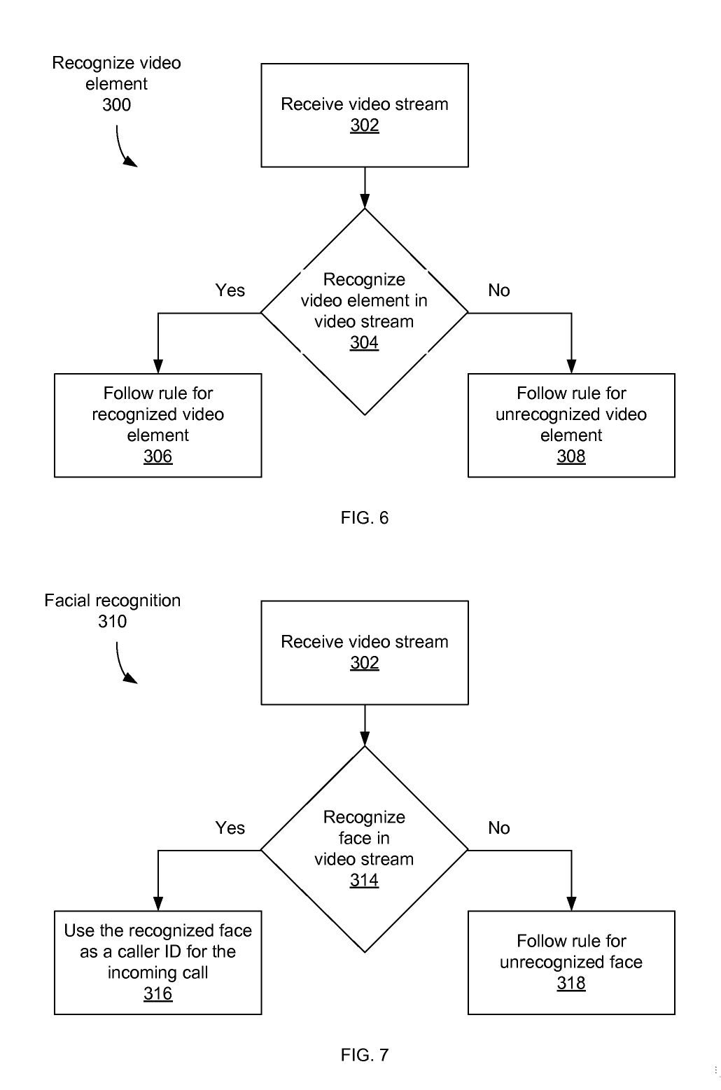

FIGS. 6-10 show various call routing scenarios, in accordance with some embodiments of the present invention. FIG. 6 shows a general method 300 to recognize and route an incoming video call based on a video element found within a selected representative frame 242. At 302, a processor receives a video stream 240 and selects a representative frame 242 containing a video element. The process of analyzing frames from the video stream 240 for a representative frame 232 may end at the first frame having a clear in-focus element (e.g., meeting a threshold test), or a best frame within a predetermined period (e.g., within 2 seconds), or a frame at a predetermined time (e.g., at 0.5 seconds into the call), or a best frame of every 10^{th} frame, or the like. At 304, the processor determines whether it recognizes a video element. If the processor recognizes the video element, the processing continues at 306. If the processor fails to recognize a video element in the selected representative frame 242, processing may revert back to selecting a new representative frame 242 or continue at 308. At 306, the processor follows a set of call routing rules 230 for a recognized video element. At 308, the processor follows the set of call routing rules 230 for an unrecognized video element or when no video element is detected.

In FIG. 7, a method 310 is shown to recognize a facial element within a selected representative frame 242. At 302, a processor selects a representative frame 232 as described above. At 314, the processor determines whether it recognizes a face 244. Two or more representative frames may be used to verify a live face and not a photograph of a face is presented. If the processor recognizes a face 244, the processing continues at 316. If the processor fails to recognize a face in the selected representative frame 242, processing may revert back to selecting a new representative frame 242 or continue at 318. At 316, the processor follows the set of call routing rules 230 for a recognized face. For example, if a face 244 is recognized, the incoming video call may be routed to a video or audio destination, such as a particular extension, voice mail or video mailbox of a company representative responsible for the calling party. At 318, the processor follows the set of call routing rules 230 for an unrecognized face or when no face is detected. For example, routing an incoming video call to a general mailbox or to the next available customer server representative.

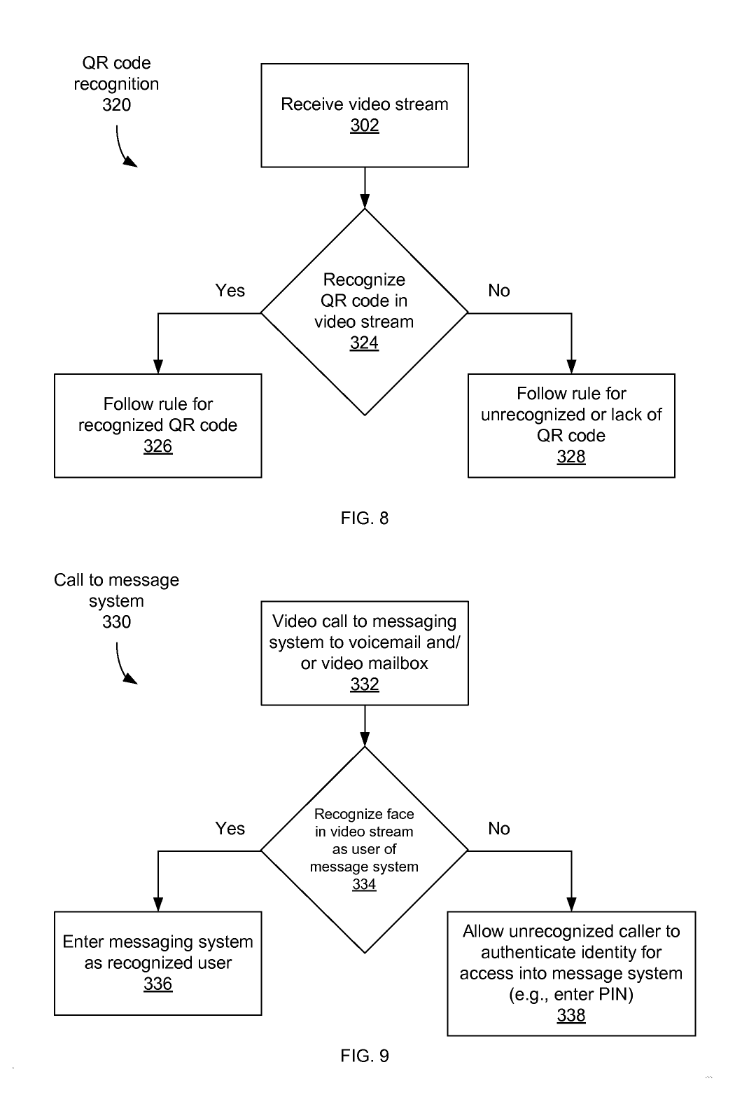

In FIG. 8, a method 320 is shown to recognize a QR code 246 or another object within a selected representative frame 242. At 302, a processor selects a representative frame 232 as described above. At 324, the processor determines whether it recognizes and decodes a valid QR code 246. The QR code 246 may contain an address and/or link to content stored in a database. For example, the QR code 246 may be an index to a database or include an instruction. The QR code 246 may identify the caller or a called or destination party. If the processor recognizes the QR code 246, the processing continues at 326. If the processor fails to recognize a QR code 246 in the selected representative frame 242, processing may revert back to selecting a new representative frame 242 or continue at 328. At 326, the processor follows the set of call routing rules 230 for a recognized QR code 246. For example, if a QR code 246 is recognized, the incoming video call may be routed to a particular conference room. At 328, the processor follows the set of call routing rules 230 for an unrecognized QR code 246 or when no QR code 246 is detected. For example, the incoming video call may be routed to an operator or an automated interactive system.

In FIG. 9, a method 330 is shown to forward a caller to a messaging system. At 332, a processor selects a representative frame 232 as described above with reference to 202. In this case, a video caller may dial a specific number or address for a voicemail and/or a video mailbox. Alternatively, a routing rule may forward a video caller to the messaging system. At 334, the processor determines whether it recognizes a video element, such as a face. If the processor recognizes the video element, the processing continues at 336. If the processor fails to recognize a video element in the selected representative frame 242, processing may revert back to selecting a new representative frame 242 or continue at 338. At 336, the processor enters a messaging system as a recognized user. That is, the processor performs authentication on the caller by the recognition status being recognized. At 338, the processor enters the messaging system as an unrecognized user prompting for authorization (e.g., requiring entering a PIN) or blocks entry into the message system.

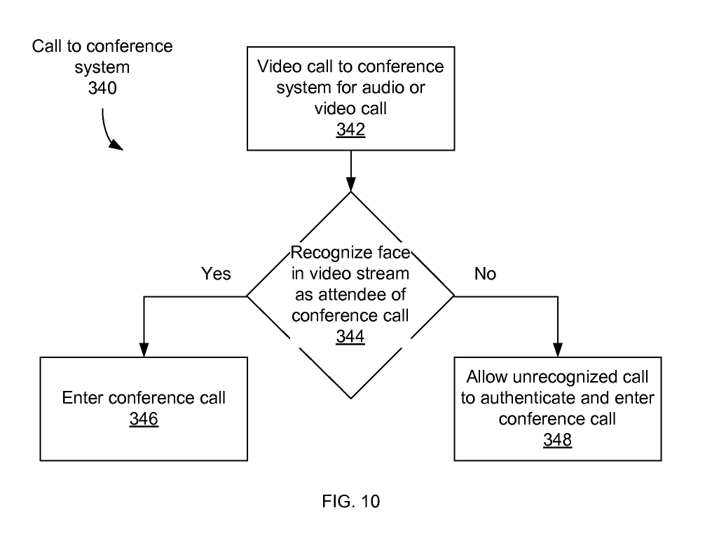

In FIG. 10, a method 340 is shown to enter a video or audio conference call. At 342, a processor selects a representative frame 232 as described above. Again, a video caller may dial a specific number or address for a conference system or may be routed to the conference system. At 344, the processor determines whether it recognizes a video element, such as a face of an invited participant of the conference call. For example, a database contains an image of the caller captured from a previous incoming video call. If the processor recognizes the video element, the processing continues at 346. If the processor fails to recognize a video element in the selected representative frame 242, processing may revert back to selecting a new representative frame 242 or continue at 348. At 346, the processor enters the calling party into a conference system for a particular conference. The processor may announce in the conference call that a recognized user or a particular invited participant has entered. At 348, the processor enters the conference system as an unrecognized user prompting for authorization (e.g., requiring entering a PIN) or alternatively blocks entry into the conference system.

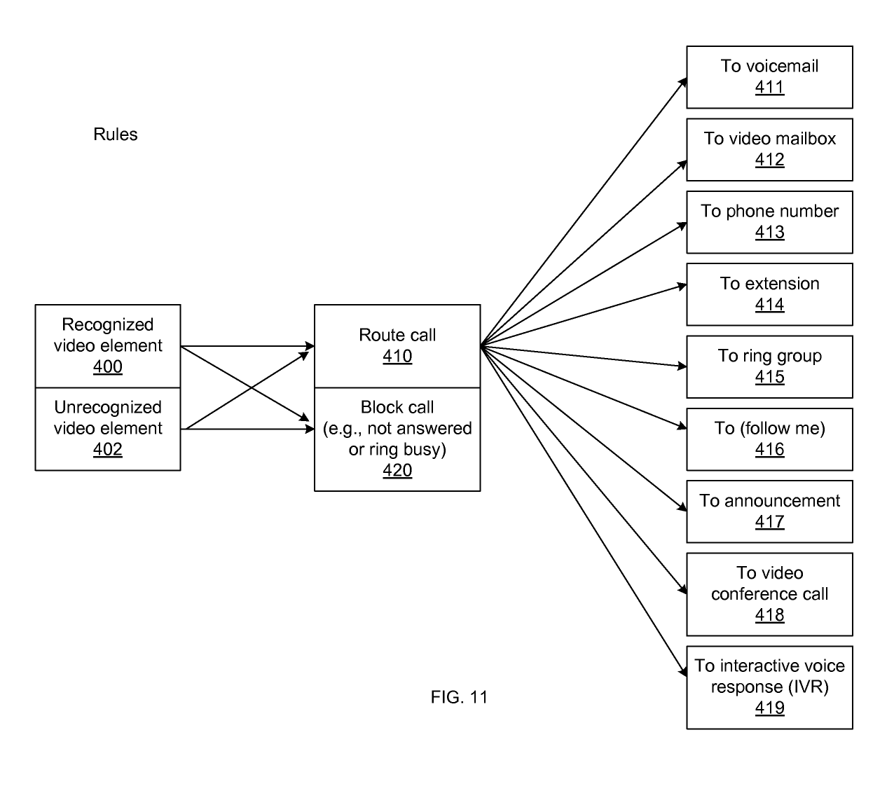

FIG. 11 illustrates an example of a set of call routing rules 230 associated with video-based routing, in accordance with some embodiments of the present invention. The set of call routing rules 230 is programmable and based on a recognition status. As a result of video recognition recognizing one or more video elements, such as a face 244, when compared to a reference video element, the recognition status is set to recognized or unrecognized. At 400, a video element is recognized. At 402, no video element is recognized; therefore, the status is set to unrecognized. Based on a particular routing rule for a video element that is recognized, routing may be set to either routing the incoming call at 410, or blocking or dropping the incoming call at 420. At 410, the particular routing rule for the recognized video element of the incoming video call may route the incoming video call as an audio call or a video call. If the call is routed as an incoming audio call, the video element of the call may be filter out. The particular routing rule may route the call to the called party's voicemail 411 or to the calling party's own voicemail for retrieval of his or her own voicemail. Similarly, the particular routing rule may route the call to the called party's video mailbox 412 or to the calling party's own video mailbox for retrieval of his or her own video mail. For example, when Mary's face is recognized, retrieve Mary's mail. If leaving a voice or video mail, the recognized video element or the reference video element may be associated with the left message.

Alternatively, the routing rule may be set to route the incoming call to a particular phone number 413. For example, whenever Bob's face is recognized, send the incoming call to a customer service number. The routing rule may route an incoming call having a particular recognized video element to a certain extension 414 or a ring group 415. For example, whenever a QR code with John's name is recognized route the incoming video call to the technical support team's group of extensions. The routing rule may be set to route the incoming call to a dynamic destination that follows a particular user (follow-me roaming 416). For example, whenever Nancy is recognized, the incoming video call is routed to her husband's latest predicted or known whereabouts.

Still the routing rule may be set to route an incoming video call to a general or particular announcement 417 based on the particular recognized video element. The routing rule may be configured to route an incoming video call to a video or audio conference room or conference call 418 based on the recognized video element. The routing rule may route a call to an interactive voice response (IVR) system 419 based on the particular recognized video element. For example, if Joe's face is recognized and is invited to a particular conference call, automatically connect the incoming call to the conference call.

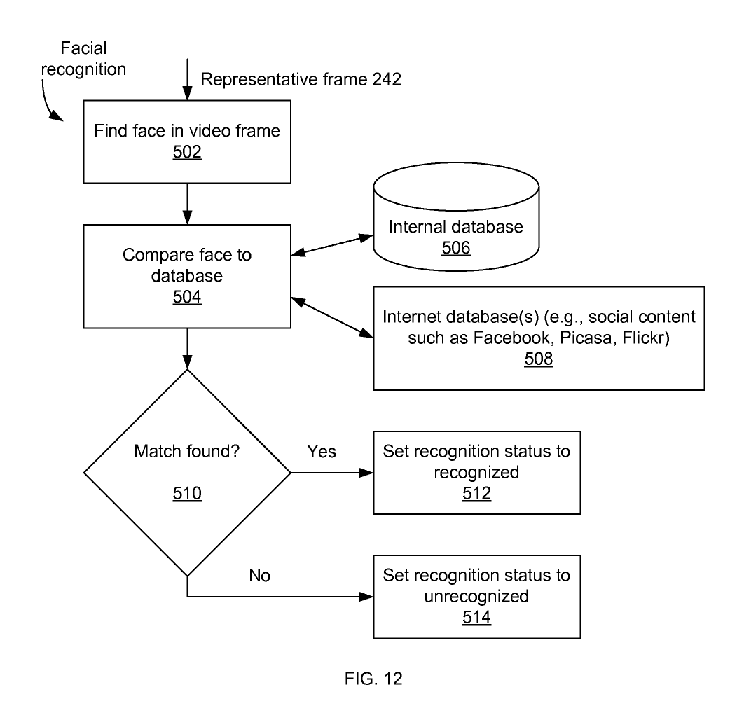

FIG. 12 shows accessing an internal database and/or an Internet database, in accordance with some embodiments of the present invention. At 502, a processor receives a representative frame 242 from a video stream 240. The processor finds a face in the representative frame 242. At 504, the processor compares the face to a database (such as from a facial database). The database may be an internal database 506 and/or an Internet database 508. The Internet database 508 may be, for example, a website with business or social content such as LinkedIn, Facebook, Picasa or Flickr. At 510, the processor determine whether a match is found between the face found in the representative frame 242 and internal database 506 and/or Internet database 508. If a match is found, the processor continues at 512. If a match is not found, the processor continues at 514. At 512, the processor sets the recognition status to recognized. Alternatively, at 514, the processor sets the recognition status to unrecognized.

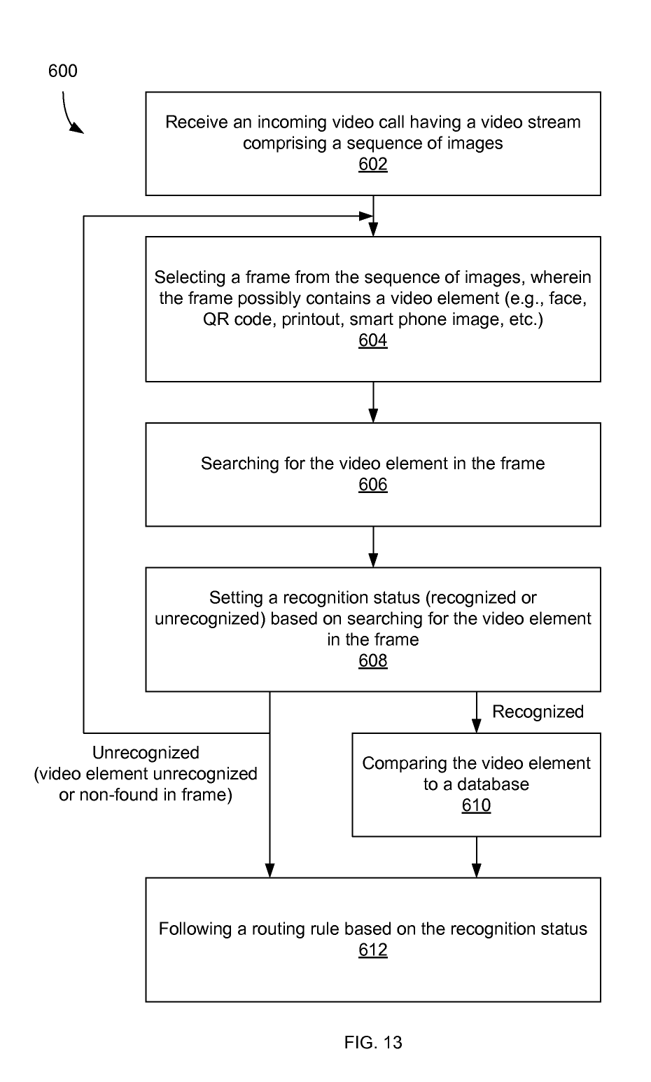

FIG. 13 illustrates a method 600 to route a caller of an incoming video call, in accordance with some embodiments of the present invention. At 602, a processor receives an incoming video call having a video stream 240 with a sequence of images. At 604, the processor selects a representative frame 242 from the sequence of images, wherein the frame possibly contains a video element (e.g., face, QR code, printout, smart phone image, etc.). At 606, the processor searches for the video element in the representative frame 242. At 608, the processor sets a recognition status (i.e., recognized or unrecognized) based on searching for the video element in the frame. If the recognition status is recognized, at 610, the processor compares the video element to a database. The database may be an internal database 506 and/or an Internet database 508. After 610 or if the recognition status is unrecognized, at 612, the processor follows a routing rule based on the set recognition status.

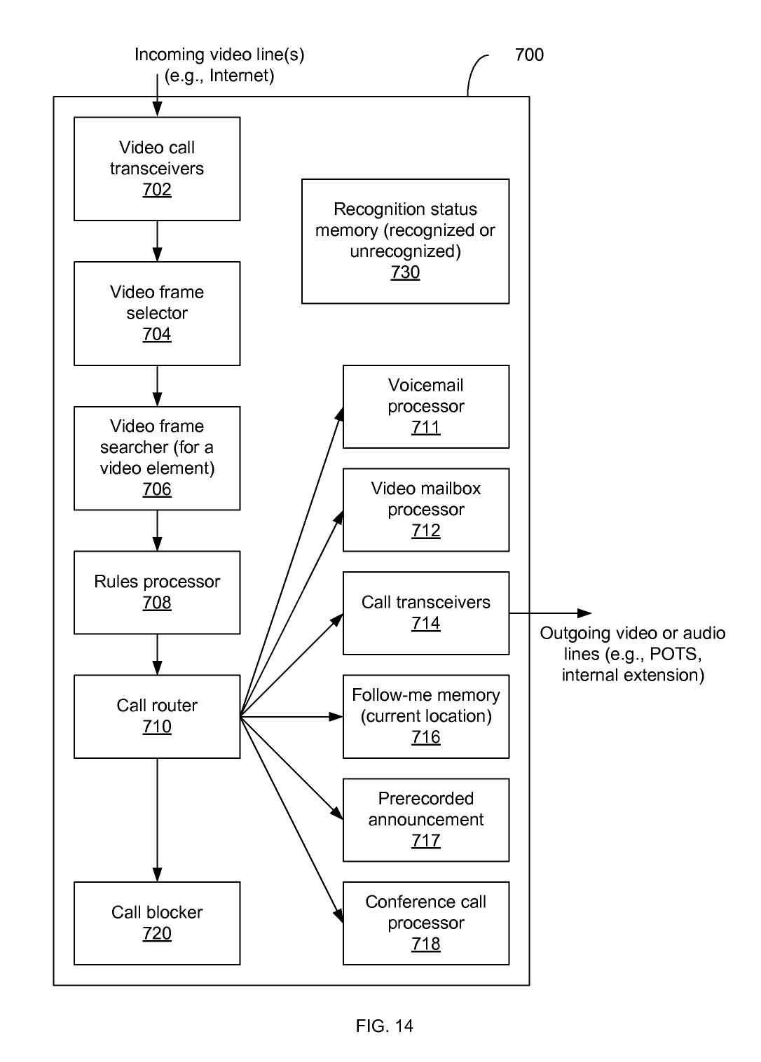

FIG. 14 shows an apparatus 700 for routing a caller of an incoming video call, in accordance with some embodiments of the present invention. The apparatus 700 receives an incoming video line or multiple incoming video lines. For example, the apparatus 700 is coupled to the Internet to receive incoming video calls. The apparatus 700 is also coupled to outgoing video and/or outgoing audio lines. The incoming and outgoing lines may be supplied with a single Ethernet connection. The apparatus 700 includes one or more video call transceivers 702 to accept the incoming video line(s) carrying an incoming video call. The video call transceivers 702 are coupled to a video frame selector 704, which selects a representative frame 242 from the incoming video call. The video frame selector 704 is coupled to a video frame searcher 706, which finds and recognizes a face or object and sets a recognition status. The video frame searcher 706 is coupled to a rules processor 708, which may uses the recognition status, called number and calling number to determine how to route or block the incoming video call.

A call router 710 and a call blocker 720 route or block the incoming video call based on results from the rules processor 708. Besides blocking calls with call blocker 720, the call router 710 is also couple to a voicemail processor 711 (to handle audio voicemail), a video mailbox processor 712 (to handle video mailboxes), a call transceiver 714 (to route incoming video calls to the outgoing video and audio lines), follow-me memory 716 (to determine at what number a called party is currently reachable), a prerecorded announcement unit 717 (to deliver a prerecorded audio message or a prerecorded video message), and a conference call processor 718 (to join incoming callers together in a video or audio conference call). Recognition status memory 730 holds the recognition status (e.g., recognized or unrecognized) of a video element contained in a representative frame 242.

The video frame selector 704, video frame searcher 706, rules processor 708, call router 710 and call blocker 720 may be modules of software executed by one or more processors in the apparatus 700. Similarly, the voicemail processor 711, the video mailbox processor 712, a call transceiver 714, the follow-me memory 716, the prerecorded announcement unit 717, and the conference call processor 718 may also be modules of software executed by one or more processors in the apparatus 700.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method for routing a caller of an incoming video call, the method comprising:
receiving, from the incoming video call, a video stream comprising a sequence of images;
selecting a frame, from the sequence of images;
searching for a video element in the frame;
setting a recognition status based on a searching for the video element in the frame, wherein the recognition status is one of recognized and unrecognized; and
following a rule, based on the recognition status, to route the incoming video call.

2. The method of claim 1, wherein the incoming video call follows at least one of an H.323 standard, a SIP standard, a WebRTC standard and an XMPP standard.

3. The method of claim 1, wherein the video element is a face.

4. The method of claim 1, wherein the video element is a QR code.

5. The method of claim 1, wherein the video element comprises an image on a smart phone.

6. The method of claim 1, wherein the video element comprises printed sheet of paper.

7. The method of claim 1, wherein setting the recognition status comprises:
finding a match between the video element and a database; and
setting the recognition status to recognized.

8. The method of claim 1, wherein recognizing the video element comprises decoding an address from the video element.

9. The method of claim 8, wherein decoding the address from the video element comprises decoding a QR code.

10. The method of claim 1, wherein the rule comprise routing the incoming video call to a particular video conference call.

11. The method of claim 1, further comprising comparing the video element to a database.

12. The method of claim 11, wherein the database comprises a facial database.

13. The method of claim 11, wherein the database comprises an image of the caller.

14. The method of claim 11, wherein the database comprises an image of the caller captured on a previous incoming video call.

15. The method of claim 1, further comprising authentication the caller based on the recognition status being recognized.

16. The method of claim 1, wherein the recognition status is recognized and the rule comprise routing the incoming video call to a voice mailbox.

17. The method of claim 1, wherein the recognition status is recognized and the rule comprise routing the incoming video call to a video mailbox.

18. The method of claim 1, wherein the recognition status is recognized and the rule comprise routing the incoming video call to a video conference.

19. The method of claim 1, wherein the recognition status is unrecognized and the rule comprise routing the incoming video call to a prerecorded video message.

20. A device for routing a caller of an incoming video call, the device comprising:
at least one video call transceiver couple to receive the incoming video call on an incoming video line;
a video frame selector coupled to the at least one video call transceiver and configured to select a representative frame from the incoming video call;
a video frame searcher coupled to the video frame selector and configured to find and recognizes video element and to set a recognition status; and
a rules processor coupled to the video frame searcher, wherein the rules processor is configured to use at least one of the recognition status, a called number and calling number to determine whether to route or block the incoming video call.

21. A method for receiving an incoming video call, the method comprising:
receiving, from the incoming video call, a video stream comprising a sequence of images from a caller;
selecting a frame, from the sequence of images; and
displaying at least a portion of the frame to a callee.

22. The method of claim 21, wherein the frame comprises a face of the caller.

23. A method for receiving an incoming video call, the method comprising:
receiving, from the incoming video call, a video stream comprising a sequence of images from a caller;
selecting a frame, from the sequence of images, comprising a video element; and
setting a recognition status based on the video element, wherein the recognition status is one of recognized and unrecognized; and
following a rule, based on the recognition status, to route the incoming video call.

24. The method of claim 23, wherein the frame comprises a face of the caller.

25. The method of claim 23, wherein following the rule comprises routing the incoming video call to an audio call.
